(19) United States
(12) Patent Application Publication
(10) Pub. No.: US 2008/0092771 A1
(43) Pub. Date: Apr. 24, 2008

(54) Phthalocyanine Inks And Their Use In Ink Jet Printing

(75) Inventors: Paul Wight, Manchester (GB); Prakash Patel, Manchester (GB)

Correspondence Address: MORGAN LEWIS & BOCKIUS LLP, 1111 PENNSYLVANIA AVENUE NW, WASHINGTON, DC, 20004, US

(73) Assignee: FUJIFILM IMAGING COLORANTS LIMITED, Manchester (GB)

(21) Appl. No.: 11/661,497

(22) PCT Filed: Aug. 8, 2005
(86) PCT No.: PCT/GB05/03103

§ 371 Date: Feb. 27, 2007

(30) Foreign Application Priority Data
Sep. 9, 2004 (GB) 0419972.5

(51) Int. Cl. C09B 47/06; C09B 47/26; C09D 11/00; B41J 2/175

(52) U.S. Cl. 106/31.49; 347/100; 347/86

(57) ABSTRACT

A composition comprising:
(a) a major dye component which is a mixture of phthalocyanine dyes of Formula (1) and salts thereof: 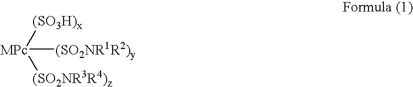 wherein: M is Cu or Ni;
Pc represents a phthalocyanine nucleus of formula; 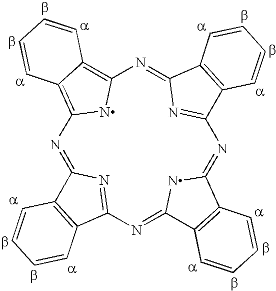
R¹ and R² independently are H or methyl;
R³ is H, methyl or optionally substituted C₁₋₈alkylNR⁵R⁶;
R⁴ is optionally substituted C₁₋₈alkylNR⁵R⁶;
R⁵ is H or optionally substituted C₁₋₄alkyl;
R⁶ is H or optionally substituted C₁₋₄alkyl; x is 0 to 3.9; y is 0 to 3.9; z is 0.1 to 4.0 the sum of (x+y+z) is 4; and the substituents, represented by x, y and z are attached to a β position on the phthalocyanine ring; and (b) a liquid medium. Also ink-jet printing processes, printed materials and ink-jet cartridges.

This invention relates to inks, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras and ink-jet printers it is becoming increasingly common for consumers to print off photographs using an ink-jet printer. This avoids the expense and inconvenience of conventional silver halide photography and provides a print quickly and conveniently.

While ink-jet printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months. Furthermore, the resultant images desirably do not fade rapidly on exposure to light or common atmospheric oxidising gases such as ozone.

Most cyan colorants used in ink-jet printing are based on phthalocyanines and problems of fading and shade change on contact with ozone are particularly acute with dyes of this class especially when they are printed onto media containing inorganic particles such as silica and/or alumina. There appears to be some aspect of the environment on the surface of such media (particularly media used for photo-realistic ink-jet printing) that promotes deterioration of these dyes in the presence of ozone.

C.I. Basic Blue 33.1 is a phthalocyanine dye that has been known and used in applications such as leather dying for many years. However its use in ink-jet printing inks has been extremely limited.

Phthalocyanines such as C.I. Basic Blue 33.1 as supplied are a complex mixture. We have surprisingly found that narrow group of compounds within this mixture gives ink-jet inks which display various advantageous properties.

Thus, the present invention provides a composition comprising:

(a) a major dye component which is a mixture of phthalocyanine dyes of Formula (1) and salts thereof: 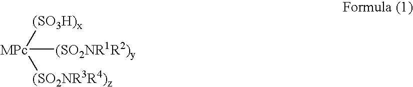
wherein:
M is Cu or Ni;
Pc represents a phthalocyanine nucleus of formula;

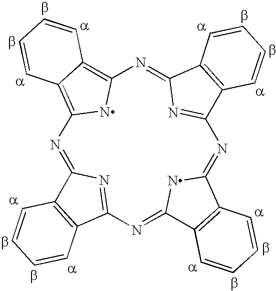

R¹ and R² independently are H or methyl;

R³ is H, methyl or optionally substituted C₁₋₈alkylNR⁵R⁶;

R⁴ is optionally substituted C₁₋₈alkylNR⁵R⁶;

R⁵ is H or optionally substituted C₁₋₄alkyl;

R⁶ is H or optionally substituted C₁₋₄alkyl;

x is 0 to 3.9;

y is 0 to 3.9;

z is 0.1 to 4.0;

the sum of (x+y+z) is 4; and

the substituents, represented by x, y and z are attached to a 4 position on the phthalocyanine ring; and

(b) a liquid medium.

When a dye of Formula (1) is made by the more usual route of sulfonating a phthalocyanine pigment followed by chlorination and then amination/amidation then the resultant product is a complex mixture comprising species with varying levels of substitution and with sulfo and sulfonamide substituents distributed randomly in both the α- and β-positions.

The phthalocyanine dyes of Formula (1) where the substituents are attached to a β-position on the phthalocyanine ring may be prepared by any method known in the art, and particularly by cyclisation of appropriate β-substituted phthalic acid, phthalonitrile, iminoisoindoline, phthalic anhydride, phthalimide or phthalamide in the presence of a suitable nitrogen source (if required), a suitable metal salt such as, for example, CuCl₂, and a base such as 1,8-diazabicyclo[5.4.0]undec-7-ene (DBU) followed by chlorination and then amination/amidation.

Preferably copper phthalocyanine dyes of Formula (1) where the sulfo and substituted sulfonamide substituents are attached to a β-position on the phthalocyanine ring are prepared by cyclisation of 4-sulfophthalic acid to phthalocyanine β-tetrasulfonic acid in the presence of a nitrogen source such as urea, a suitable metal salt such as, for example, CuCl₂ and a base such as 1,8-diazabicyclo[5.4.0]undec-7-ene (DBU) to give phthalocyanine β-tetrasulfonic acid, a reaction well known in the art. The phthalocyanine β-tetrasulfonic acid is then chlorinated and the sulfonyl chloride groups so formed are reacted with compounds of formula HNR¹R² and HNR³R⁴ wherein R¹, R², R³ and R⁴ are as hereinbefore defined. This reaction is preferably performed in water at a pH above 7. Typically the reaction is performed at a temperature of 30 to 70° C. and is usually complete in less than 24 hours. The compounds of formula HNR¹R² and HNR³R⁴ may be used as a mixture or added sequentially.

Many of the compounds of formula HNR¹R² and HNR³R⁴ are commercially available, for example ammonia and N,N-dimethylaminopropylamine, others may be made easily by a skilled person using methods which are well known in the art.

The ratio of sulfo to sulfonamide substituents may be varied by varying the nature and amount of chlorinating agent used, the relative amounts of compounds of formula HNR¹R² and HNR³R⁴ used and the reaction conditions in both reactions.

When phthalocyanine β-tetrasulfonic acid is an intermediate in a route to compounds of Formula (1) it may be chlorinated by reacting with any suitable chlorinating agent.

Chlorination is preferably carried out by treating the phthalocyanine β-tetrasulfonic acid with chlorosulfonic acid preferably in the presence of an acid halide such as thionyl chloride, sulfuryl chloride, phosphorous pentachloride, phosphorous oxychloride or phosphorous trichloride.

In the compounds of the present invention the α-positions of the phthalocyanine ring are preferably unsubstituted, that is they carry a hydrogen substituent.

Preferably M is Cu.

Preferably R¹ and R² are H.

Preferably R³ is H or methyl more preferably H.

R⁴ is preferably optionally substituted C₁₋₄alkylNR⁵R⁶. More preferably R⁴ is unsubstituted C₁₋₄alkylNR⁵R⁵, especially C₃alkylNR⁵R⁵.

R⁵ is preferably unsubstituted C₁₋₄alkyl. More preferably R⁵ is methyl.

R⁶ is preferably unsubstituted C₁₋₄alkyl. More preferably R⁶ is methyl.

Preferably x is greater than 0, more preferably greater than 0.1 and especially greater than 0.5.

In one preferred embodiment y is 0.

In another preferred embodiment y is greater than 0, more preferably greater than 0.1 and especially greater than 0.5.

Preferably z is greater than 1, more preferably z is greater than 2.

Optional substituents which may be present on R³, R⁴, R⁵ and R⁶ are preferably selected from optionally substituted alkoxy (preferably C₁₋₄-alkoxy), optionally substituted aryl (preferably phenyl), optionally substituted aryloxy (preferably phenoxy), optionally substituted heterocyclic, polyalkylene oxide (preferably polyethylene oxide or polypropylene oxide), nitro, cyano, halo, ureido, -hydroxy, ester, —COR^{a}, —CONR^{a}R^{b}, carboxyester, sulfone, and —SO₂NR^{a}R^{b}, wherein R^{a} and R^{b} are each independently H or optionally substituted alkyl (especially C₁₋₄-alkyl). Optional substituents for R^{a} and R^{b} may be selected from the substituents described above.

A preferred compound of Formula (1) is of Formula (2) and salts thereof: 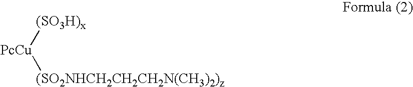
wherein:

Pc represents a phthalocyanine nucleus of formula;

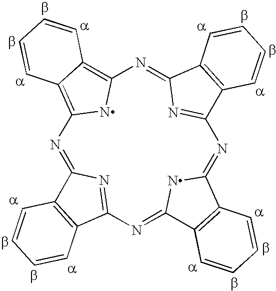

x is 0 to 3.9;

z is 0.1 to 4;

the sum of (x+z) is 4; and

the substituents, represented by x and z are attached to a β position on the phthalocyanine ring.

Preferences for x and z are as outlined above.

The compounds of Formula (1) are also preferably free from fibre reactive groups. The term fibre reactive group is well known in the art and is described, for example, in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups excluded from the compounds of Formula (1) there may be mentioned aliphatic sulfonyl groups which contain a sulfate ester group in beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring, for example a triazinyl halide.

Acid or basic groups on the compounds of Formula (1) may be in the form of a salt. Thus, the Formulae shown herein include the compounds in salt form.

Preferred salts are formed with organic acids bearing a single acidic, preferably a carboxylic acid, group. Examples of these acids include; aliphatic acids such as acetic acid and trifluoro acetic acid and aromatic acids such as salicylic acid and p-toluene sulfonic acid.

The compounds of Formula (1) may exist in tautomeric forms other than those shown in this specification. These tautomers are included within the scope of the present invention.

The liquid medium (b) may comprise water, water and organic solvent or organic solvent free from water. Preferably the liquid medium (b) comprises water and organic solvent or organic solvent free from water.

When the medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises organic solvent free from water, (i.e. less than 1% water by weight) the solvent preferably has a boiling point of from 30° to 200° C., more preferably of from 40° to 150° C., especially from 50° to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent then preferably a polar solvent is preferably included since this enhances solubility of the compound of Formula (1) in the liquid medium. Examples of polar solvents include C₁₋₄-alcohols.

It is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the medium is organic solvent free from water it is a mixture of 2 to 5 different organic solvents. This allows a medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the composition to modify the shade and performance properties. Examples of such colorants include C.I. Direct Yellow 86, 132, 142 and 173; C.I. Direct Blue 307; C.I. Food Black 2; C.I. Direct Black 168 and 195; C.I. Acid Yellow 23.

The term major dye component may be taken to indicate that the dye of Formula (1) is added to the ink so as to have a discrete colour effect. Thus, if the composition of the present invention is black ink and a cyan dye of Formula (1) is added to this ink for the purpose of shading then the cyan dye of Formula (1) would still be considered to be a major dye component.

If the composition of the present invention contains phthalocyanine dyes other than those of Formula (1) then preferably at least 50% by weight, more preferably 70% by weight, especially 80% by weight, more especially 90% by weight, particularly 95% by weight and more particularly 99% by weight of the total amount of phthalocyanine dye is of Formula (1) wherein the substituents, represented by x, y and z, are attached to a β position on the phthalocyanine ring.

Preferably the only phthalocyanine dye present in the compositions of the present invention is of Formula (1) wherein the substituents, represented by x, y and z, are attached to a β position on the phthalocyanine ring.

It is preferred that the composition according to the invention is ink suitable for use in an ink-jet printer. Ink suitable for use in an ink-jet printer is ink which is able to repeatedly fire through an ink-jet printing head without causing blockage of the fine nozzles.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other component of the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

Preferred compositions comprise:

(a) from 0.01 to 30 parts of compounds of Formula (1); and

(b) from 70 to 99.99 parts of a liquid medium;

wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as high concentration cyan ink, low concentration cyan ink or both high concentration and low concentration ink. In the latter case this can lead to improvements in the resolution and quality of printed images. Thus the present invention also provides a composition where component (a) is present in an amount of 2.5 to 7 parts, more preferably 2.5 to 5 parts (high concentration ink) or component (a) is present in an amount of 0.5 to 2.4 parts, more preferably 0.5 to 1.5 parts (low concentration ink).

Compositions according to the present invention yield prints that display a good fastness to water, ozone and light. In particular, prints prepared using these inks display excellent light and ozone fastness.

A second aspect of the invention provides a process for forming an image on a substrate comprising applying ink suitable for use in an ink-jet printer, according to the first aspect of the invention, thereto by means of an ink-jet printer.

The ink-jet printer preferably applies the ink to the substrate in the form of droplets that are ejected through a small orifice onto the substrate. Preferred inkjet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred.

Photographic quality paper is particularly preferred.

A third aspect of the present invention provides a material preferably paper, plastic, a textile, metal or glass, more preferably paper, an overhead projector slide or a textile material, especially paper more especially plain, coated or treated papers printed with a composition according to the first aspect of the invention or by means of a process according to the second aspect of the invention.

It is especially preferred that the printed material of the third aspect of the invention is a photographic reproduction.

A fourth aspect of the present invention provides an ink-jet printer cartridge comprising a chamber and an ink wherein the ink is in the chamber and the ink is as defined in the first aspect of the present invention. The cartridge may contain a high concentration ink and a low concentration ink, as described in the first aspect of the invention, in different chambers.

The invention is further illustrated by the following Examples in which all parts and percentages are by weight unless otherwise stated.

Example Ink 1

An ink comprising a compound of formula:
CuPc(SO₃H)_{0.8} (SO₂NHCH₂CH₂CH₂N(CH₃)₂)_{3.4}
wherein all the substituents are attached to a β-position of the phthalocyanine ring; was prepared by dissolving 3 parts of the compound in 97 parts of a liquid medium comprising:
5 parts 2-pyrrolidone;
5 parts thiodiglycol;
1 parts Surfynol™ 465 (a non-ionic surfactant available from Air Products Inc.); and
89 parts water: and adjusting the pH to pH 4 with acetic acid.

The compound used in Example Ink 1 was prepared as described below.

Stage 1

Preparation of Copper Phthalocyanine tetra-β-sulfonate

Potassium 4-sulfophthalic acid (56.8 g), urea (120 g), CuCl₂ (6.9 g), ammonium molybdate (1.2 g) and 1,8-diazabicyclo[5.4.0]undec-7-ene (DBU) (7.5 g) were mixed in a reaction vessel. The mixture was warmed in stages (130° C./30 minutes, 150° C./30 minutes, 180° C./30 minutes, 220° C./30 minutes) over 2 hours and the melt which formed was stirred at 220° C. for a further 2 hours. The resultant solid was extracted 4 times with hot water (4×200 ml) and the extract was filtered to remove insoluble material. The filtrate was stirred at between 60° C.-70° C. and then sufficient NaCl was added to give a 7% salt solution. Stirring was continued and the precipitate was filtered, washed with a 10% salt solution (200 ml) and pulled dry by vacuum. The resultant damp solid (77.6 g) was slurried in acetone, filtered and dried, first at room temperature and then at 50° C.

Stage 2

Phosphorous oxychloride (11.92 g) was added dropwise to chlorosulfonic acid (116.5 g) over 5 to 10 minutes while keeping the temperature below 30° C. When all the POCl₃ had been added, the product of stage 1 (22 g) was added portion-wise while keeping the reaction temperature below 60° C., this addition took 20-30 minutes. The reaction mixture was stirred at 50-60° C. for 15-20 minutes. The temperature of the reaction mixture was then gradually increased to 138-140° C. over 30 minutes, held at this temperature for 6.5 hours and then stirred overnight at room temperature. The mixture was added to water/ice/NaCl/concentrated HCl (120 ml/120 g/15 g/8 ml). The solid that precipitated was filtered, washed with ice cold acidified 5% salt solution and pulled dry using a vacuum pump. The resultant damp paste (39 g) in water (100 ml) was added to a mixture of N,N dimethylaminopropylamine (16.32 g) and water (100 ml) at 0°-10° C. Pyridine (5 ml) added and the mixture was stirred at 0° to 10° C. (pH>11) for 0.5 hours. The reaction mixture was then stirred at 40-45° C. for 1.5 hours, at room temperature overnight and, the next day, at 80-85° C. for 2.5 hours. At the end of this time the reaction mixture was salted with NaCl. The solid which precipitated was filtered and then washed with an 20% NaCl solution. The resultant damp solid was dissolved in deionised water, dialysed, filtered and then dried at 70° C. to give 7.7 g of product.

Example Ink 2

An ink comprising a compound of formula:
CuPc(SO₂NHCH₂CH₂CH₂N(CH₂CH₂)₂)_{4.1}
wherein all the substituents are attached to a β-position of the phthalocyanine ring; was prepared by dissolving 3 parts of the compound in 97 parts of the liquid medium described in Example Ink 1.

The compound used in Example Ink 2 was prepared as described below.

Stage 1

Copper phthalocyanine tetra-β-sulfonate was prepared as in Example 1, stage 1.

Stage 2

Phosphorous oxychloride (6 g) was added dropwise to chlorosulfonic acid (58 g) over 5-10 minutes while keeping the temperature below 30° C. When all the POCl₃ had been added, the product of stage 1 (11 g) was added portion-wise while keeping the reaction temperature below 60° C., this addition took 20-30 minutes. The reaction mixture was stirred at 50-60° C. for 15-20 minutes. The temperature of the reaction mixture was then gradually increased to 138-140° C. over 30 minutes, held at this temperature for 6.5 hours and then stirred overnight at room temperature. The mixture was then added to water/ice/NaCl/concentrated HCl (120 ml/120 g/15 g/8 ml). The solid which precipitated was filtered, washed with ice cold acidified 5% NaCl solution and pulled dry using a vacuum pump. The resultant damp paste (44 g) in water (100 ml) was added to a mixture of N,N diethylaminopropylamine (20.8 g), water (150 ml) at 0°-10° C. and the mixture was stirred at 0° to 10° C. (pH 10.5-11) for 0.5 hours. The reaction mixture was then stirred at 40° C., pH 10.5 for 3 hours, at room temperature overnight and then at 80-85° C., pH 10.5 for a further 2 hours. At the end of this time the product was precipitated from the reaction mixture by the addition of NaCl and washed with a 5% NaCl solution and then 100 ml of water. The resultant damp solid was dissolved in deionised water, dialysed, filtered and then dried at 70° C. to give 9.15 g of product.

Example Ink 3

An ink comprising a compound of formula:
CuPc 4-(SO₃H)_{0.7}4-(SO₂NHCH₂CH₂N(CH₃)₂)_{3.7}
wherein all the substituents are attached to a β-position of the phthalocyanine ring; was prepared by dissolving 3 parts of the compound in 97 parts of the liquid medium described in Example Ink 1.

The compound used in Example Ink 3 was prepared as described in Example 1 except that N,N-dimethylaminoethylamine was used in place of N,N-dimethylaminopropylamine.

Comparative Example Ink 1

An ink was prepared as described in Example Ink 1 containing a compound of formula
CuPc(SO₃H)_{0.8}(SO₂NHCH₂CH₂CH₂N(CH₃)₂)_{2.9}
wherein the substituents are attached to both the α- and β-positions of the phthalocyanine ring system.

The compound used in the ink of the Comparative Example was prepared as follows:

Stage 1

Phosphorous oxychloride (6.14 g) was added dropwise to chlorosulfonic acid (58.25 g) over 5-10 minutes while keeping the temperature below 30° C. When all the POCl₃ had been added, copper phthalocyanine (5.87 g) was added portion-wise while keeping the reaction temperature below 60° C., this addition took 10-15 minutes. The temperature of the reaction mixture was then gradually increased to 138-140° C. and the reaction mixture was held at this temperature for 6.5 hours and then stirred overnight at room temperature. The mixture was added to water/ice/NaCl/concentrated HCl (60 ml/60 g/10 g/4 ml). The solid which precipitated was filtered, washed with ice cold acidified 5% NaCl and then pulled dry using a vacuum pump. The resultant damp paste (39 g) was added to N,N dimethylaminopropylamine (16 g) in 150 ml of water at 0°-5° C. and stirred at pH 11 for 0.5 hours. The reaction mixture was then stirred at 40-45° C. for 1 hour, at pH 10-10.5, 80° C. for 0.5 hours (the pH was maintained at this value by the addition of an aqueous solution of N,N dimethylaminopropylamine) and then stirred at room temperature overnight. At the end of this time the pH of the reaction mixture was adjusted to 8.6 with concentrated HCl and the product precipitated with NaCl. The product was filtered and then washed with 50% NaCl solution. The resultant damp solid was slurried in deionised water, dialysed and then dried at 70° C. to give 8.9 g of product.

Ink-Jet Printing

The ink of Example ink 1 and the ink of the Comparative Example Ink were filtered through a 0.45 micron nylon filter and then incorporated into empty print cartridges using a syringe.

The cartridges containing the inks were incorporated into an ink-jet printer and the inks were then printed onto Xerox 4024 Premium Multipurpose White Paper (Xerox 4024), HP Premium Plus Photo Paper (HPPP), Epson Premium Glossy Photopaper (“SEC PM”) and Canon PR101 Photopaper (PR101). The depth of print was adjusted so that the initial optical density of prints of the two inks was the same.

Print Evaluation

The prints were tested for ozone fastness by exposure to 1 ppm ozone at 40° C., 50% relative humidity for 24 hrs in a Hampden 903 Ozone cabinet. Fastness of the printed ink to ozone is judged by the difference in the optical density before and after exposure to ozone.

Light-fastness of the printed image was assessed by fading the printed image in an Atlas Ci5000 Weatherometer for 100 hours and then measuring the change in the optical density.

Optical density measurements were performed using a Gretag spectrolino spectrophotometer set to the following parameters:

| | |
|---|---|
| Measuring Geometry | 0°/45° |
| Spectral Range | 400-700 nm |
| Spectral Interval | 20 nm |
| Illuminant | D65 |
| Observer | 2° (CIE 1931) |
| Density | Ansi A |
| External Filler | None |

Light and Ozone fastness were assessed by the percentage change in the optical density of the print, where a lower figure indicates higher fastness, and the degree of fade. The degree of fade is expressed as ΔE where a lower figure indicates higher light fastness. ΔE is defined as the overall change in the CIE colour co-ordinates L, a, b of the print and is expressed by the equation ΔE=(ΔL²+Δa²+Δb²)^{0.5}.

The light and ozone fastness of the ink of Example Ink 1 and the Comparative Example Ink are shown below:

Results

Light Fastness

Optical Density

| | % OD Loss | % OD Loss | % OD Loss | % OD Loss |
|---|---|---|---|---|
| | Xerox 4024 | HPPP | PR101 | SEC PM |
| Ink 1 | 1 | 15 | 8 | 14 |
| Comparative | 6 | 45 | 30 | 32 |
| Ink | | | | |

Degree of Fade

| | ΔE | ΔE | ΔE | ΔE |
|---|---|---|---|---|
| | Xerox 4024 | HPPP | PR101 | SEC PM |
| Ink 1 | 6 | 8 | 8 | 4 |
| Comparative | 8 | 21 | 16 | 11 |
| Ink | | | | |

Ozone Fastness

Optical Density

| | % OD Loss | % OD Loss |
|---|---|---|
| | PR101 | SEC PM |
| Ink 1 | 4 | 8 |
| Comparative | 11 | 24 |
| Ink | | |

Degree of Fade

| | ΔE | ΔE |
|---|---|---|
| | PR101 | SEC PM |
| Ink 1 | 3 | 2 |
| Comparative | 5 | 8 |
| Ink 1 | | |

Thus, the ink of the present invention, wherein the phthalocyanine carries substituents only in the β-position, provides prints with a significantly improved light and ozone fastness when compared to prints of an analogous ink where an identical phthalocyanine dye is used except that it is substituted in both the α- and the β-positions.

Further Inks

The inks described in Tables A and B may be prepared wherein the Compound described in the first column is the Compound made in the above example of the same number. Numbers quoted in the second column onwards refer to the number of parts of the relevant ingredient and all parts are by weight. The inks may be applied to paper by thermal or piezo ink-jet printing.

The following abbreviations are used in Tables A and B:
PG=propylene glycol
DEG=diethylene glycol
NMP=N-methyl pyrollidone
DMK=dimethylketone
IPA=isopropanol
MEOH=methanol
2P=2-pyrollidone
MIBK=methylisobutyl ketone
P12=propane-1,2-diol
BDL=butane-2,3-diol
CET=cetylammonium bromide
PHO=Na₂HPO₄ and
TBT=tertiary butanol

TDG=thiodiglycol

TABLE A

| | Dye | | | | | | | Na | | | | |
|---|---|---|---|---|---|---|---|---|---|---|---|---|
| Example | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 2 | 3.0 | 90 | | 5 | 5 | | 0.2 | | | | | |
| 3 | 10.0 | 85 | 3 | | 3 | 3 | | | | 5 | 1 | |
| 1 | 2.1 | 91 | | 8 | | | | | | | | 1 |
| 2 | 3.1 | 86 | 5 | | | | | 0.2 | 4 | | | 5 |
| 3 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 2 | 5 | 65 | | 20 | | | | | 10 | | | |
| 3 | 2.4 | 75 | 5 | 4 | | 5 | | | | 6 | | 5 |
| 1 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 1 | 10.0 | 80 | 2 | 6 | 2 | 5 | | | 1 | | 4 | |
| 1 | 1.8 | 80 | | 5 | | | | | | | 15 | |
| 1 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| | 6.0 | 91 | | | 4 | | | | | | 5 | |

TABLE B

| | Dye | | | | | | | | | | | |
|---|---|---|---|---|---|---|---|---|---|---|---|---|
| Example | Content | Water | PG | DEG | NMP | CET | TBT | TDG | BDL | PHO | 2P | PI2 |
| 1 | 3.0 | 80 | 15 | | | 0.2 | | | | | 5 | |
| 2 | 9.0 | 90 | | 5 | | | | | | 1.2 | | 5 |
| 3 | 1.5 | 85 | 5 | 5 | | 0.15 | 5.0 | 0.2 | | | | |
| 1 | 2.5 | 90 | | 6 | 4 | | | | | 0.12 | | |
| 2 | 3.1 | 82 | 4 | 8 | | 0.3 | | | | | | 6 |
| 3 | 0.9 | 85 | | 10 | | | | | 5 | 0.2 | | |
| 1 | 8.0 | 90 | | 5 | 5 | | | 0.3 | | | | |
| 2 | 4.0 | 70 | | 10 | 4 | | | | 1 | | 4 | 11 |
| 3 | 2.2 | 75 | 4 | 10 | 3 | | | | 2 | | 6 | |
| 1 | 10.0 | 91 | | | 6 | | | | | | 3 | |
| 1 | 9.0 | 76 | | 9 | 7 | | 3.0 | | | 0.95 | 5 | |
| 1 | 5.0 | 78 | 5 | 11 | | | | | | | 6 | |
| 1 | 5.4 | 86 | | | 7 | | | | | | 7 | |
| 1 | 2.1 | 70 | 5 | 5 | 5 | 0.1 | 0.2 | 0.1 | 5 | 0.1 | 5 | |
| 1 | 2.0 | 90 | | 10 | | | | | | | | |
| 1 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 1 | 10 | 80 | | | | | | 8 | | | 12 | |
| 1 | 10 | 80 | | 10 | | | | | | | | |

1. A composition comprising:
(a) a major dye component which is a mixture of phthalocyanine dyes of Formula (1) and salts thereof: 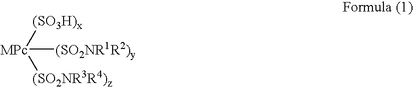
wherein:
M is Cu or Ni;
Pc represents a phthalocyanine nucleus of formula; 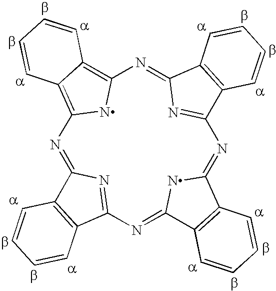
R¹ and R² independently are H or methyl;
R³ is H, methyl or optionally substituted C₁₋₈alkylNR⁵R⁶;
R⁴ is optionally substituted C₁₋₈alkylNR⁵R⁶;
R⁵ is H or optionally substituted C₁₋₄alkyl;
R⁶ is H or optionally substituted C₁₋₄alkyl;
x is 0 to 3.9;
y is 0 to 3.9;
z is 0.1 to 4.0
the sum of (x+y+z) is 4; and
the substituents, represented by x, y and z are attached to a □ position on the phthalocyanine ring; and
(b) a liquid medium.

2. A composition according to claim 1 wherein M is Cu.

3. A composition according to either claim 1 or claim 2 wherein x is greater than 0.5

4. A composition according to either claim 1 or claim 2 wherein y is 0.

5. A composition according to either claim 1 or claim 2 wherein y is greater than 0.5.

6. A composition according to either claim 1 or claim 2 wherein z is greater than 2.

7. A composition according to claim 1 or claim 2 wherein the compound of Formula (1) is of Formula (2) and salts thereof: 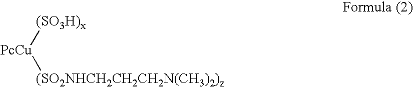
wherein:
Pc represents a phthalocyanine nucleus of formula; 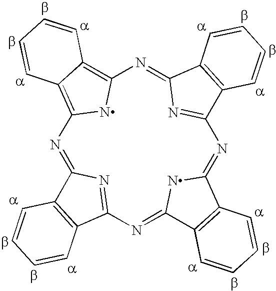
x is 0 to 3.9;
z is 0.1 to 4;
the sum of (x+z) is 4; and
the substituents, represented by x and z are attached to a □ position on the phthalocyanine ring.

8. A composition according to either claim 1 or claim 2 wherein the liquid medium (b) comprises water and organic solvent or organic solvent free from water.

9. A composition according to either claim 1 or claim 2 which is ink suitable for use in an ink-jet printer.

10. A process for forming an image on a substrate comprising applying ink according to claim 9 thereto by means of an ink-jet printer.

11. A material printed with a composition according to either claim 1 or claim 2.

12. A printed material according to claim 11 which is a photographic reproduction.

13. An ink-jet printer cartridge comprising a chamber and an ink wherein the ink is in the chamber and the ink is as defined in claim 9.
